(19) United States
(12) Patent Application Publication
(10) Pub. No.: US 2025/0080492 A1
(43) Pub. Date: Mar. 6, 2025

(54) Multiple Pending Device Configuration Request Messages

(71) Applicant: Arista Networks, Inc., Santa Clara, CA (US)

(72) Inventors: Joseph Anthony Fitzpatrick, Dublin (IE); Eamon Doyle, Dublin (IE); Peter Edwards, Dublin (IE)

(21) Appl. No.: 18/457,986

(22) Filed: Aug. 29, 2023

(51) Int. Cl. H04L 61/5014; H04L 41/0803

(52) U.S. Cl. CPC H04L 61/5014; H04L 41/0803

(57) ABSTRACT

A network device may transmit device configuration request messages of different types for network address assignment operations that are pending in parallel. The network device may complete a corresponding message exchange operation to obtain device configuration information based on a response to one of the request messages. If desired, if no responses are received for the initial set of device configuration request messages within an allocated time, the network device may subsequently send additional device configuration request messages for other network address assignment operations that are also pending in parallel.

### BACKGROUND

This relates to network devices, and more particularly, to network devices configured to obtain device configuration information such as a device network address.

In one illustrative system, a network device can obtain the device configuration information as part of a device self-provisioning operation. As an example, an initially un-provisioned network device may be configured to perform the self-provisioning operation by first obtaining its network address.

### BRIEF DESCRIPTION OF THE DRAWINGS

FIG. 1 is a diagram of an illustrative network in which a network device is configured to obtain device configuration information in accordance with some embodiments.

FIG. 2 is a diagram of an illustrative network device in accordance with some embodiments.

FIG. 3 is a diagram of an illustrative network address assignment system communicating with a network device in accordance with some embodiments.

FIG. 4 is a diagram of an illustrative network device configured to provide multiple DHCP instances in accordance with some embodiments.

FIG. 5 is a diagram illustrating communication between a network device and a network address assignment system based on multiple DHCP instances in accordance with some embodiments.

FIG. 6 is a flowchart of illustrative operations for handling multiple device configuration request messages in accordance with some embodiments.

FIG. 7 is a flowchart of illustrative operations for sequentially sending two sets of device configuration request messages in accordance with some embodiments.

FIG. 8 is a flowchart of illustrative operations for obtaining device configuration information with parallelization in accordance with some embodiments.

FIG. 9 is a flowchart of illustrative operations for performing device provisioning in accordance with some embodiments.

### DETAILED DESCRIPTION

A network can convey network traffic (e.g., in the form of packets, frames, etc.) between host devices. To properly route and forward the network traffic, the network can include a number of network devices configured with networking data such as forwarding decision data, routing decision data, network policy information, etc.

Network devices typically require provisioning and the reception of networking data to be operational within the network. To simplify the process of provisioning or configuring a network device for operation, the network device may initiate its own provisioning operation (sometimes referred to as a self-provisioning operation). The network device may, as part of the provisioning operation, obtain its network address such as its IPv4 (Internet Protocol version 4) address and/or IPv6 (Internet Protocol version 6) address and other device configuration information (sometimes referred to herein as device configuration parameters). The network device may receive its network address from a network address assignment server (e.g., a server implementing DHCP (Dynamic Host Configuration Protocol) such as DHCPv4 (Dynamic Host Configuration Protocol version 4) for IPV4 addresses and/or stateful DHCPv6 (Dynamic Host Configuration Protocol version 6) for IPV6 addresses) or may generate its network address based on received information (e.g., using stateless address auto-configuration (SLAAC)). The network device may further receive a network address (e.g., a Uniform Resource Locator or web address) of a bootstrap server (e.g., a server that stores information based on which the network device can be provisioned or bootstrapped). The network device may communicate with the bootstrap server to receive the provisioning information (sometimes referred to as bootstrapping data or artifacts) and process the provisioning information to perform the self-provisioning operation using protocols such as zero touch provisioning (ZTP) or secure zero touch provisioning (SZTP).

Depending on the configuration of the network and/or the configuration of the network address assignment server, it may be necessary for the network device to convey device configuration request messages to the network address assignment server that contain a particular type of information such as a particular type of unique device identifier (e.g., a device serial number or a device hardware address) and/or based on a particular protocol (e.g., using DHCPv4, stateful DHCPv6, or stateless DHCPv6) in order to obtain the desired device network address and/or other device configuration information. In other words, a network device, when deployed in a first type of network with a first type of network address assignment server, should send a first type of device configuration request message to obtain its device configuration information from the first type of network address assignment server. The same network device, when deployed in a second type of network with a second type of network address assignment server, should send a second type of device configuration request message to obtain its device configuration information from the second type of network address assignment server.

Without advanced knowledge of (e.g., without stored information indicative of) its specific deployment, as might be the case when performing a self-provisioning operation, the network device may send numerous device configuration request messages of different types in a sequential trial-and-error manner to properly obtain its device configuration information. This process can be inefficient and time-consuming because the network device typically waits to resolve an instance of a device address assignment operation (during which the device configuration might be obtained) before starting another instance of a device address assignment operation (if the first instance has failed to obtain the desired device configuration information).

Accordingly, it may be desirable to provide a network device configured to perform device address assignment operations more efficiently or generally obtain device configuration information (e.g., the device network address) more efficiently. Accordingly, the network device may be configured to send device configuration request messages of different types that are awaiting response in parallel and to complete a corresponding message exchange (or handshake) operation to obtain its device configuration based on a response to one of the request messages. If desired, the network device may be configured to subsequently send additional device configuration request messages for other (e.g., backup) types of network address assignment operations that are also pending in parallel if no responses are received for the initial set of device configuration request messages within an allocated time. In such a manner, the same network device may exhibit enhanced versatility due to its ability to efficiently obtain device configuration information such as its network address across various types of deployments (e.g., implementing various device network address assignment schemes).

Configurations in which network address assignment operations are performed as part of a device self-provisioning operation are sometimes described herein as an illustrative example. In general, the network address assignment operations may be used outside of the context of device self-provisioning (e.g., in other contexts or as requested by other applications executing on a network device). As such, if desired, the network address assignment operations described herein (e.g., using multiple pending device configuration request messages) may be used in any suitable system to obtain device configuration information.

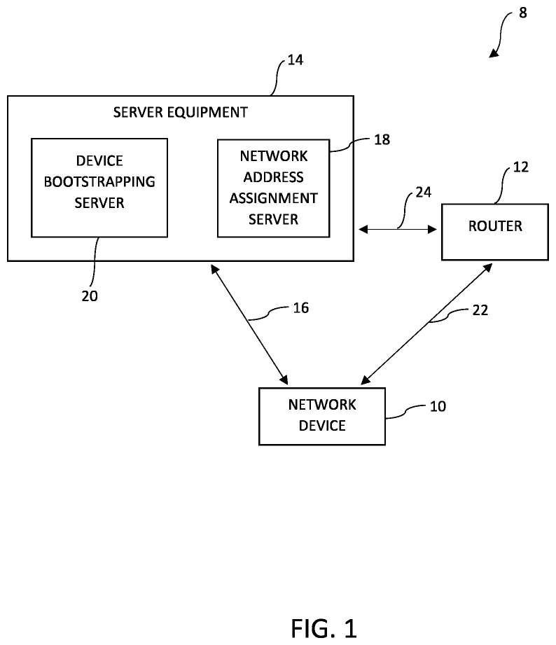

An illustrative networking system in which a network device is configured to perform device network address assignment operation(s) is shown in FIG. 1. In particular, FIG. 1 shows an illustrative network (portion) 8 which may be of any suitable scope and/or form part of a larger network of any suitable scope. As examples, network 8 may include, be, or form part of one or more local segments, one or more local subnets, one or more local area networks (LANs), one or more campus area networks, a wide area network, etc. Network 8 may include any suitable number of different network devices that connect corresponding host devices of network 8 to one another. At least some of these network devices may be connected by one or more wired technologies or standards such as Ethernet (e.g., using copper cables and/or fiber optic cables), thereby forming a wired network portion. If desired, network 8 may also include a wireless network portion coupled to the wired network portion. If desired, network 8 may include or be coupled to internet service provider networks (e.g., the Internet) or other public service provider networks, private service provider networks (e.g., multiprotocol label switching (MPLS) networks), and/or other types of networks such as telecommunication service provider networks (e.g., a cellular network based on one or more standards as described in the 3GPP specifications such as GSM, UMTS, LTE, 5G, etc.).

In general, network devices in network 8 can include any number of switches (e.g., single-layer (L2) switches and/or multi-layer (L2 and L3) switches), bridges, routers, gateways, hubs, repeaters, firewalls, wireless access points, network devices serving other networking functions, network devices that include the functionality of two or more of these devices, management devices that control the operation of one or more of these network devices, and/or other types of network devices.

In the example of FIG. 1, the network devices of network 8 include at least network device 10, such as a multi-layer switch or another type of network device, and router 12. Network 8 may also include one or more host devices or host equipment such as server equipment 14. Configurations in which network device 10 is an un-provisioned network device (e.g., not a fully provisioned network device) when initially coupled or connected to other elements of network 8 are sometimes described herein as an illustrative example.

In these configurations, network device 10 may communicate with different portions of server equipment 14 via one or more communication paths 16 in an attempt to perform a network device provisioning operation that provisions and configures device 10 itself for operation. In particular, network device 10 may first communicate with a network address assignment server 18 implemented on server equipment 14 (e.g., a DHCP server such as server equipment implementing DHCPv4, implementing (stateful or stateless) DHCPv6, implementing a variation of DHCP, implementing a server that is compliant with only some portions of DHCP, and/or implementing other network address assignment protocols) to obtain a network address, or generally device configuration information, for network device 10. After obtaining its network address, network device 10 may generate one or more network interfaces based on the obtained device configuration information and then communicate, using the one or more network interfaces, with a device bootstrapping server 20 implemented on server equipment 14 to obtain networking data, executable files, and/or other bootstrapping data.

Network device 10 may be considered fully provisioned and ready to perform networking operations (e.g., routing protocols, traffic routing, traffic forwarding, etc.) after successfully executing the obtained executable files such as compiled binary executable files and/or script-based executable files, storing the obtained networking data, and/or generally processing the provisioning information, as examples. While both shown in FIG. 1 to be within server equipment 14, servers 18 and 20 may be implemented on distinct and separate pieces of server computing equipment (e.g., on different processing circuitry or sets of processors, using different storage circuitry accessible by the corresponding processing circuitry, on the same or different server racks, etc.) at server equipment 14 or may be implemented on shared computing equipment (e.g., the same processing circuitry or set of processors, using the same storage circuitry accessible by the processing circuitry, etc.) at server equipment 14. Servers 18 and 20 may be implemented at different sites or generally on different network portions of network 8 (e.g., on different local segments) or may be implemented at the same site (e.g., on the same local segment or different local segments).

Before, when, and/or after communicating with server equipment 14 as part of the device provisioning operation, network device 10 may be in communication with router 12 via one or more communication paths 22. As examples, router 12 may be a router on the same local segment or subnet as network device 10, server 18, and/or server 20, may be an edge router or gateway, may be a core router, may be a virtual router implemented on server equipment, or generally may be a router implemented in any suitable manner at any suitable location within network 8. Router 12 may be communicatively coupled to server equipment 14 (e.g., server 18 and/or server 20) via one or more communication paths 24.

Communication paths 16, 22, and 24 may be implemented using network paths of network 8. These network paths may include direct cable connections with or without intervening network devices. In other words, each path 16, each path 22, and/or each path 24 may span across portions of network 8 (e.g., one or more network devices therein) to provide the connectivity illustrated in FIG. 1. While shown in FIG. 1 as separate paths, paths 16, 22, and 24 may include paths or path portions that overlap one another.

In one illustrative arrangement, a given path 16 may be implemented by paths 22 and 24 and intervening router 12. In an arrangement where network device 10 lacks a direct connection to server equipment 14, any connection between network device 10 and server equipment 14 may include router 12 (e.g., serving as a relay device). In particular, router 12 may contain a relay agent executing on its processing circuitry to perform relaying of address assignment messages (e.g., DHCP messages), or generally device configuration request and response messages as described herein, for network device 10 and server equipment 14 (or more specifically, server 18). This relaying of DHCP messages and/or other types of messages occurs prior to device 10 having or being assigned a network address and thus will differ from normal packet forwarding (e.g., forwarding of packets that identify the network address of device 10). If desired, other routers and/or network devices (e.g., in addition to router 12) may also serve as relay devices to relay DHCP messages and/or other messages between device 10 and server equipment 14 (e.g., server 18). As an illustrative example, an intervening router coupled along path 24 (e.g., between router 12 and server equipment 14) may also contain a relay agent executing on its processing circuitry. This intervening router along path 24 and router 12 may collectively relay the DHCP messages and/or other messages between device 10 and server 18. In general, any number of intervening (relay) devices (e.g., zero, one, two, etc.) at any suitable locations (e.g., along paths 16, 22, and/or 24) may be involved in the conveyance of messages such as network address assignment messages, or generally device configuration request and response messages as described herein, between network device 10 and server equipment 14 (e.g., between device 10 and server 18, between device 10 and server 20, etc.).

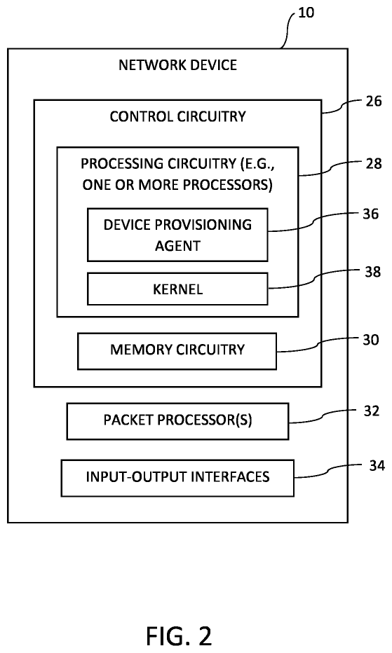

FIG. 2 is a diagram of an illustrative network device such as network device 10 in FIG. 1. In some configurations described herein as an illustrative example, network device 10 may be an un-provisioned multi-layer switch or other type of network device that automatically initiates a device provisioning operation to provision itself after being introduced to network 8 in FIG. 1 (e.g., after being communicatively coupled to components of network 8 such as router 12 and/or server equipment 14).

As shown in FIG. 2, network device 10 may include control circuitry 26 having processing circuitry 28 and memory circuitry 30, one or more packet processors 32, and input-output interfaces 34 (sometimes referred to as network interfaces) mounted within a housing of network device 10. If desired, the housing may include an exterior cover (e.g., a plastic exterior shell, a metal exterior shell, or an exterior shell formed from other rigid or semi-rigid materials) and/or a supporting substrate that provide structural support and/or protection for the components of network device 10 mounted within and/or on the housing. In one illustrative arrangement, network device 10 may be or form part of a modular network device system (e.g., a modular switch system having removably coupled modules usable to flexibly expand characteristics and capabilities of the modular switch system such as to increase the number of ports, provide specialized functionalities, etc.). In another illustrative arrangement, network device 10 may be a fixed-configuration network device (e.g., a fixed-configuration switch having a fixed number of ports and/or a fixed hardware configuration).

Processing circuitry 28 may include one or more processors or processing units based on central processing units (CPUs), based on graphics processing units (GPUs), based on microprocessors, based on general-purpose processors, based on host processors, based on coprocessors, based on microcontrollers, based on digital signal processors, based on programmable logic devices such as a field programmable gate array device (FPGA), based on application specific system processors (ASSPs), based on application specific integrated circuit (ASIC) processors, and/or based on other processor architectures.

Processing circuitry 28 may run (e.g., execute) a network device operating system and/or other software/firmware that is stored on memory circuitry 30. Memory circuitry 30 may include one or more non-transitory (tangible) computer-readable storage media that stores the operating system software and/or any other software code, sometimes referred to as program instructions, software instructions, software, data, instructions, or code. As an example, the device network address assignment operations, such as the transmission of parallel device configuration request messages, described herein may be stored as (software) instructions on the one or more non-transitory computer-readable storage media (e.g., in portion(s) of memory circuitry 30 in network device 10). The corresponding processing circuitry (e.g., one or more processors of processing circuitry 28 in network device 10) may process or execute the respective instructions to perform the corresponding network address assignment operations. Memory circuitry 30 may be implemented using non-volatile memory (e.g., flash memory or other electrically-programmable read-only memory configured to form a solid-state drive), volatile memory (e.g., static or dynamic random-access memory), hard disk drive storage, removable storage devices (e.g., storage device removably coupled to device 10), and/or other storage circuitry. Processing circuitry 28 and memory circuitry 30 as described above may sometimes be referred to collectively as control circuitry 26 (e.g., implementing a control plane of network device 10).

As other illustrative operations in addition to device network address assignment operations (e.g., as part of a device provisioning operation), processing circuitry 28 may execute network device control plane software such as operating system software, routing policy management software, routing protocol agents or processes, routing information base agents, and other control software, may be used to support the operation of protocol clients and/or servers (e.g., to form some or all of a communications protocol stack such as the TCP/IP stack), may be used to support the operation of packet processor(s) 32, may store packet forwarding information, may execute packet processing software, and/or may execute other software instructions that control the functions of network device 10 and the other components therein. Some of these operations such as those associated with routing policy management software, routing protocol agents or processes, routing information base agents, and packet processing software may occur after the device provisioning operation has successfully completed.

Packet processor(s) 32 may be used to implement a data plane or forwarding plane of network device 10. Packet processor(s) 32 may include one or more processors or processing units based on central processing units (CPUs), based on graphics processing units (GPUs), based on microprocessors, based on general-purpose processors, based on host processors, based on coprocessors, based on microcontrollers, based on digital signal processors, based on programmable logic devices such as a field programmable gate array device (FPGA), based on application specific system processors (ASSPs), based on application specific integrated circuit (ASIC) processors, and/or based on other processor architectures.

Packet processor 32 may receive incoming network traffic via input-output interfaces 34, parse and analyze the network traffic, process the network traffic based on packet forwarding decision data (e.g., in a forwarding information base) and/or in accordance with network protocol(s) or other forwarding policy, and forward (or drop) the network traffic accordingly. The packet forwarding decision data may be stored on a portion of memory circuitry 30 and/or other memory circuitry integrated as part of or separate from packet processor 32.

Input-output interfaces 34 may include different types of communication interfaces such as Ethernet interfaces (e.g., one or more Ethernet ports), optical interfaces, Bluetooth interfaces, Wi-Fi interfaces, and/or other network interfaces for connecting network device 10 to the Internet, a local area network, a wide area network, a mobile network, and generally other network device(s), peripheral devices, and other computing equipment (e.g., host equipment such as server equipment, user equipment, etc.). As an example, input-output interfaces 34 may be formed by configuring physical ports or sockets with device configuration information. These physical ports may be physically coupled and electrically connected to corresponding mating connectors of external components. Ports may have different form-factors to accommodate different cables, different modules, different devices, or generally different external equipment.

In configurations in which network device 10 is an initially un-provisioned network device, processing circuitry 28 on network device 10 may execute a device provisioning agent 36 (sometimes referred to herein as a device provisioning process 36) that helps manage and facilitate the device self-provisioning operation described herein after the initially un-provisioned device 10 is supplied with power and is communicatively coupled to router 12 and/or server equipment 14 (e.g., by having a network connection). If desired, this provisioning operation may be initiated automatically by executing agent 36 based on one or more criteria being met. The one or more criteria can include network device 10 being connected to a power source, network device 10 being coupled to one or more elements of network 8, network device 10 lacking an initial configuration, network device 10 receiving one or more user inputs such as the pressing of a button, the providing of a key or other security element, or generally any specified input via a user interface, and/or other suitable provisioning criteria. Configured in this manner, network device 10 may sometimes be referred to herein as a network device configured for secure zero touch provisioning, zero touch provisioning, one touch provisioning, or minimal touch provisioning.

Processing circuitry 28 may also execute threads or tasks for a kernel such as kernel 38. Kernel 38 may, among other functions, implement network interfaces (e.g., interfaces 34 over physical ports) based on communication protocols (e.g., transport layer protocols, network layer protocols, data link layer protocols, etc.) and form corresponding communication sockets using device configuration information, thereby implementing a communication protocol stack (e.g., a TCP/IP stack) with which network device 10 can communicate with external equipment.

As part of the device provisioning operation, device 10 (e.g., device provisioning agent 36) may obtain the device configuration information such as the network (e.g., IP) address of network device 10. Kernel 38 may use the obtained device configuration information to form one or more network layer interfaces (e.g., one or more IPv4 or IPv6 interfaces) for device 10. Device provisioning agent 36 may subsequently communicate with device bootstrapping server 20 to obtain bootstrapping data (e.g., executable files, networking data such as routing and forwarding decision data, network policy information, etc., and generally other types of bootstrapping data) via the network interfaces (e.g., interfaces 34) established by kernel 38.

Processing circuitry 28 may execute device provisioning agent 36 and kernel 38 by executing software instructions stored on memory circuitry 30. While device provisioning agent 36 and kernel 38 are described to perform respective parts of the device provisioning operation for provisioning device 10, this is merely illustrative. Processing circuitry 28 may be organized in any suitable manner (e.g., to have any other agents or processes instead of or in addition to device provisioning agent 36 and/or kernel 38) to perform each part of the device provisioning operation. Accordingly, processing circuitry 28 may sometimes be described herein to perform the device provisioning operation instead of specifically referring to the one or more agents, processes, and/or kernel executed by processing circuitry 28.

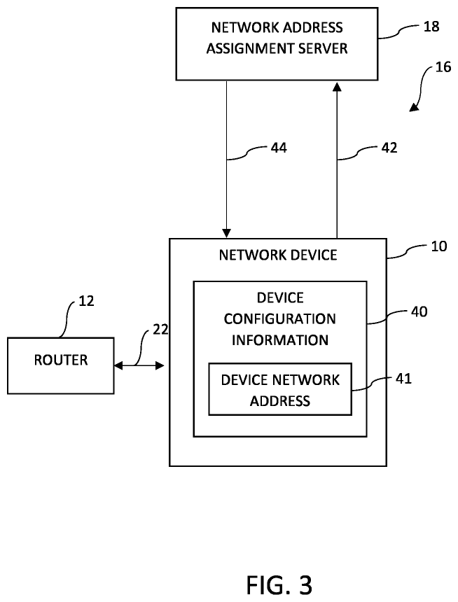

As part of the device provisioning operation described above and/or as part of other device operations, a network device may be configured to obtain its network address and/or other device configuration information from network address assignment server 18. FIG. 3 is a diagram showing illustrative communication between a network device such as network device 10 and a network address assignment system, e.g., containing network address assignment server 18 and router 12. As examples, the network address assignment server may be configured to implement a DHCPv4 server or a stateful DHCPv6 server that conveys the device network address and device configuration information to network device 10 based on a DHCPv4 protocol or based on a stateful DHCPv6 protocol, may be configured to implement a stateless DHCPv6 server based on a stateless DHCPv6 protocol that conveys device configuration information which is used in combination with a device-generated device network address (e.g., using SLAAC), and/or may be configured to implement other types of servers based on any other suitable network address assignment protocols. If desired, server 18 (e.g., at least some or all of the network address assignment functionalities of server 18 as described herein) may be implemented by a router on the local segment of network device 10 in addition to or instead of by dedicated server equipment.

As shown in FIG. 3, network device 10 may send or transmit (e.g., broadcast, multicast, unicast, etc.) one or more messages 42 to server 18 via communication link 16, may receive one or more messages 44 from server 18 via communication link 16, and/or may communicate with router 12 via communication link 22 to obtain device configuration information 40. The obtained device configuration information 40 may include (e.g., assigned or leased) information as received in one or more messages 44 and/or received in communication with router 12, and may include device-generated information based on the information as received in one or more messages 44 and/or received in communication with router 12. While device configuration information 40 is described herein to include network address 41 of network device 10 (e.g., either dynamically assigned to device 10 by server 18 or internally generated by device 10 based at least in part on received information), this is merely illustrative. Obtained device configuration information 40 may also include other types of network and device configuration information (sometimes referred to as device configuration parameters) such as subnet mask information, one or more available router (sometimes referred to as default gateway) IP addresses, one or more domain name system (DNS) server addresses, domain name information, and a device network address lease time, as just a few examples. Device network address 41 obtained (e.g., received or generated) as part of information 40 for device 10 may be an IPV4 address for device 10 or an IPV6 address for device 10, and may be a locally unique IP address or a globally unique IP address.

The types of messages 42 and 44 and the manner in which messages 42 are sent may depend on the implementation of network address assignment server 18 (e.g., whether server 18 implements DHCPv4, stateful DHCPv6, and/or stateless DHCPv6). As described herein, stateful protocols (e.g., DHCPv4 and stateful DHCPv6) may be used to obtain device (dynamic) state information (e.g., an assigned or leased network address of a device, a lease time after which the leased network address expires and requires renewal, etc.) in addition to general network information (e.g., one or more domain name system (DNS) server addresses, domain name information, etc.), whereas stateless protocol(s) (e.g., stateless DHCPv6) may be used to obtain general network information and not obtain device (dynamic) state information.

In the example of DHCPv4, device 10 may broadcast (e.g., using Layer 2 and Layer 3 broadcast addresses) a DHCPv4 discover message 42 to find DHCPv4 servers from which device 10 can request and obtain information 40. Device 10 may receive a unicast DHCPv4 offer message 44 containing information 40 sent from server 18 in response to DHCPv4 discover message 42. Information 40 may include a device IPv4 address 41 and other device configuration information. Device 10 may, responsive to DHCPv4 offer message 44, broadcast a DHCPv4 request message 42, thereby informing server 18 (and any other available DHCPv4 servers) that the offered lease information in DHCPv4 offer message 44 sent by server 18 has been accepted. Device 10 may receive a unicast DHCPv4 acknowledgement message 44 (e.g., also containing information 40) sent from server 18 in response to DHCPv4 request message 42 to complete the network address assignment operation. Device 10 may subsequently configure its network interfaces with received device configuration information 40 (e.g., as described in connection with kernel 38 in FIG. 2).

In the example of stateful (and if desired, stateless) DHCPv6, device 10 may broadcast (e.g., using Layer 2 and Layer 3 broadcast messages) a DHCPv6 solicit message 42 to find DHCPv6 servers from which device 10 can request and obtain information 40. Device 10 may receive a unicast DHCPv6 advertise message 44 indicating availability of server 18 sent from server 18 in response to DHCPv6 solicit message 42. Thereafter, operations may diverge depending on whether stateful or stateless DHCPv6 is implemented by the network address assignment system (e.g., by server 18).

In the case of stateful DHCPv6, device 10 may, responsive to DHCPv6 advertise message 44, unicast a DHCPv6 request message 42, requesting information 40 (e.g., one or more IPv6 addresses 41 and other device configuration information). Device 10 may receive a unicast DHCPv6 reply message 44 containing information 40 (e.g., only the requested device configuration information) sent from server 18 in response to DHCPv6 request message 42 to complete the network address assignment operation. Device 10 may subsequently configure its network interfaces with received device configuration information 40 (e.g., as described in connection with kernel 38 in FIG. 2).

In the case of stateless DHCPv6, prior to communicating with server 18, device 10 may have already received information such as a network prefix (e.g., using an exchange of Router Solicitation and Router Advertisement messages with router 12), which in combination with a device identifier or other identifier information, can be used to obtain (e.g., locally generate) a device IPV6 address 41 for device 10 (e.g., using SLAAC). In other words, device 10 may generate part of the obtained information 40 (e.g., its IPv6 address 41). To obtain other desired device configuration information, device 10 may unicast a DHCPv6 information-request message 42 requesting information 40 other than the (already-generated) IPv6 address 41 for device 10 such as DNS server IP addresses, domain name information, and/or other device configuration information. If desired, the transmission of the DHCPv6 information-request message 42 may be responsive to the reception of DHCPv6 advertise message 44. Device 10 may subsequently receive a unicast DHCPv6 reply message 44 containing information 40 (e.g., only the requested device configuration information) sent from server 18 in response to DHCPv6 information-request message 42 to complete the network address assignment operation. Device 10 may subsequently configure its network interfaces with internally-generated and received device configuration information 40 (e.g., as described in connection with kernel 38 in FIG. 2).

As described herein, messages 42 (e.g., whether sent to implement DHCPv4, stateful DHCPv6, stateless DHCPv6, or other network address assignment protocols) are generally referred to herein as device configuration request messages at least because they serve as part of the request process for device configuration information 40. In an analogous manner, messages 44 (e.g., whether sent to implement DHCPv4, stateful DHCPv6, stateless DHCPv6, or other network address assignment protocols) are generally referred to herein as device configuration response messages that are received by device 10 from server 18 in response to corresponding device configuration request messages 42. A set of messages 42 and 44 for a given protocol, or generally a network address assignment scheme, implements a message exchange (handshake) operation between device 10 and server 18 to request and receive the appropriate portion of device configuration information 40 (e.g., the assigned network address of device 10 and device configuration parameters in the case of DHCPv4 or stateful DHCPv6, device configuration parameters without an assigned network address for device 10 in the case of stateless DHCPv6).

Regardless of the protocol or network address assignment scheme being used, device configuration request message 42 (e.g., DHCPv4 discover message 42, DHCPv6 solicit message 42, or DHCPv6 information request message 42) may include a device identifier of device 10 based on which the requested device configuration information 40 may be obtained (e.g., based on which server 18 can lease an IP address and obtain the appropriate relevant device configuration information). There may be many types of device identifiers that are usable in message 42 for each network address assignment operation (e.g., for each protocol). As some illustrative examples, the device identifier (e.g., a DHCP unique identifier) may be a device hardware (e.g., Media Access Control (MAC)) address, a device's (manufacturer) serial number, a device's DNS name, a link-layer address of a device's network interface (with or without a concatenated timestamp), an Enterprise Number plus additional information specific to the enterprise (vendor or manufacturer), and a Universally Unique Identifier (e.g., as described in Request for Comment (RFC) 6355). In general, the device identifier may be a unique identifier of the device (e.g., at least unique within the subnet of device 10 if not universally unique).

A given network device 10 may be deployed in various networking environments that implements one of many possible network address assignment protocols and/or is configured to use device configuration request messages containing one of many possible device identifiers. To facilitate the use of network device 10 in different networking environment, it may be desirable for device 10 to be configured to function within any of these networking environments (e.g., make use of multiple network address assignment protocols and/or make use of multiple types of device identifiers within device configuration request messages).

While some network devices may sequentially attempt different types of network address assignment operations in a sequential trial-and-error manner (e.g., sequentially using different protocols and/or different device identifiers, not knowing which of these different operations may be successful), this process can be inefficient and time-consuming because the network device typically waits to resolve an instance of a device address assignment operation before starting another instance of a device address assignment operation. Accordingly, it may be further desirable for device 10 to perform these different device address assignment operations in a more efficient manner.

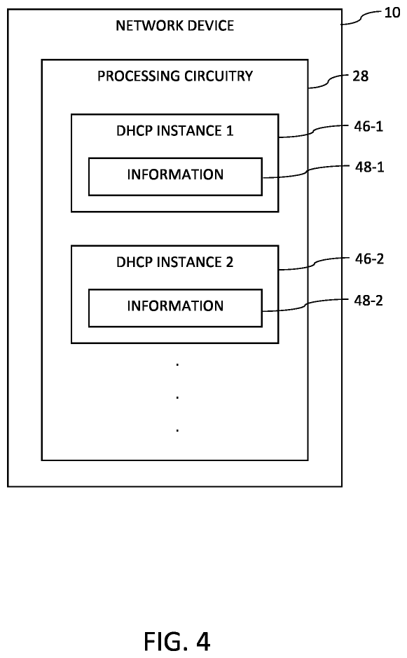

FIG. 4 is a diagram of an illustrative network device 10 configured to perform multiple network address assignment operations (e.g., as described in connection with FIG. 3) with parallelization. Configurations in which network device 10 performs multiple instances of network address assignment operations (e.g., the transmission and reception of messages 42 and 44 as described in connection with FIG. 3) compliant with DHCP (referring to both DHCPv4 and DHCPv6) are sometimes described herein as an illustrative example. If desired, network device 10 may perform multiple instances of other types of network address assignment protocols.

In the example of FIG. 4, processing circuitry 28 may execute, based on software instructions stored on memory circuitry 30, multiple DHCP instances such as DHCP instance 46-1 and DHCP instance 46-2 (and any additional DHCP instances 46) in parallel. Each of these parallelly-executing DHCP instances 46 may have different characteristics by storing and using different state and/or parameter information 48 (e.g., information 48-1 differing from information 48-2). As examples, DHCP instances 46-1 and 46-2 may use different DHCP protocols and/or different device identifiers, and/or may generally attempt different types of device address assignment operations (e.g., the transmission and reception of messages 42 and 44 as described in connection with FIG. 3 separately based on information 48-1 and 48-2).

In one illustrative arrangement, DHCP instance 46-1 may be a DHCPv4 instance while DHCP instance 46-2 may be a stateful DHCPv6 instance. In this illustrative arrangement, DHCPv4 instance 46-1 and DHCPv6 instance 46-2 may use the same device identifier to send respective device configuration request messages (e.g., send DHCPv4 and DHCPv6 messages 42 containing the same device identifier identifying device 10) or may use different device identifiers to send respective device configuration request messages (e.g., send DHCPv4 and DHCPv6 messages 42 containing different device identifiers identifying device 10).

In another illustrative arrangement, DHCP instance 46-1 may be a DHCPv4 instance while DHCP instance 46-2 may be another DHCPv4 instance. In this illustrative arrangement, DHCPv4 instance 46-1 and DHCPv4 instance 46-2 may use different device identifiers to send respective device configuration request messages (e.g., send different DHCPv4 messages 42 containing different device identifiers identifying device 10).

In yet another illustrative arrangement, DHCP instance 46-1 may be a (stateful or stateless) DHCPv6 instance while DHCP instance 46-2 may be another (stateful or stateless) DHCPv6 instance. In this illustrative arrangement, DHCPv6 instance 46-1 and DHCPv6 instance 46-2 may use different device identifiers to send respective device configuration request messages (e.g., send different DHCPv6 messages 42 containing different device identifiers identifying device 10).

If desired, these illustrative arrangements may be used in combination. In some configurations described herein as an illustrative example, processing circuitry 28 may initially execute four instances of stateful DHCP in parallel: a first DHCPv4 instance that uses a first device identifier of device 10 such as a device serial number, a second DHCPv4 instance that uses a second device identifier of device 10 such as a device hardware address, a third stateful DHCPv6 instance that uses the first device identifier of device 10, and a fourth stateful DHCPv6 instance that uses the second device identifier of device 10. If the four initial instances of stateful DHCP all fail to obtain the desired device configuration information (e.g., fail to obtain a network address for device 10), processing circuitry 28 may further execute two instances of stateless DHCP in parallel: a first stateless DHCPv6 instance that uses the first device identifier of device 10 and a second stateless DHCPv6 instance that uses the second device identifier of device 10.

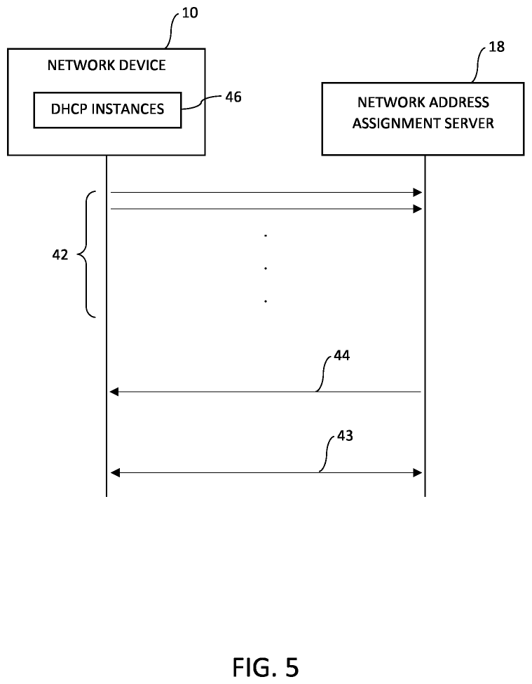

FIG. 5 is a diagram of illustrative operations performed using multiple DHCP instances 46 such as those described in connection with FIG. 4 executing on device 10 (e.g., executing on processing circuitry 28 to obtain device configuration information 40). As shown in FIG. 5, using DHCP instances 46, device 10 may transmit a set of device configuration request messages 42. As examples, these device configuration request messages 42 may include one or more (e.g., all) of a DHCPv4 discover message containing a first device identifier for device 10, a DHCPv4 discover message containing a second device identifier for device 10, additional DHCPv4 discover message(s) containing other device identifier(s) for device 10, a DHCPv6 solicit message containing the first device identifier for device 10, a DHCPv6 solicit message containing the second device identifier for device 10, and additional DHCPv6 solicit message(s) containing the other device identifier(s) for device 10. As other examples, these device configuration request messages 42 may include one or more (e.g., all) of a DHCPv6 information request message containing the first device identifier for device 10, a DHCPv6 information request message containing the second device identifier for device 10, and additional DHCPv6 information request message(s) containing the other device identifier(s) for device 10.

Device 10 may transmit these messages 42, at least some of which are received by network address assignment server 18. Responsive to the received message 42, network address assignment server 18 may respond to a given one of the messages 42 (e.g., based on how network address assignment server 18 is configured) by sending a corresponding device configuration response message 44.

As one illustrative example, network address assignment server 18 may receive DHCPv4 messages 42 and DHCPv6 messages 42 such as a first DHCPv6 solicit message containing a first device identifier and a second DHCPv6 solicit message containing a second device identifier. In instances where server 18 is configured to operate using DHCPv6 and with the second device identifier, server 18 may respond to only the second DHCPv6 solicit message containing the second device identifier (and not to any of the received DHCPv4 messages 42) by sending a corresponding DHCPv6 advertise message based on the second device identifier.

As another illustrative example, network address assignment server 18 may receive DHCPv6 messages 42 and DHCPv4 messages 42 such as a first DHCPv4 discover message containing a first device identifier and a second DHCPv4 discover message containing a second device identifier. In instances where server 18 is configured to operate using DHCPv4 and with the first device identifier, server 18 may respond to only the first DHCPv4 discover message containing the first device identifier (and not to any of the received DHCPv6 messages 42) by sending a corresponding DHCPv4 offer message containing the device configuration information requested based on the first device identifier.

As yet another illustrative example, network address assignment server 18 may receive stateless DHCPv6 messages 42 as a first DHCPv6 information request message containing a first device identifier and a second DHCPv6 information request message containing a second device identifier. In instances where server 18 is configured to operate using stateless DHCPv6 and with the first device identifier, server 18 may respond to only the first DHCPv6 information request message containing the first device identifier by sending a corresponding DHCPv6 reply message 44 containing the device configuration information requested based on the first device identifier.

After a given DHCP instance 46 receives a device configuration response message 44 from server 18, the given DHCP instance 46 may proceed with the transmission and reception of additional messages 43 to complete its message exchange (or handshaking) operation with server 18. In the example of DHCPv4 (e.g., the given DHCP instance 46 being based on DHCPv4), device 10 (e.g., the given DHCP instance 46) may further transmit a DHCPv4 request message 43 to server 18 and receive a DHCPv4 acknowledge message 43 from server 18 to complete the message exchange operation. In the example of stateful DHCPv6 (e.g., the given DHCP instance 46 being based on stateful DHCPv6), device 10 (e.g., the given DHCP instance 46) may further transmit a DHCPv6 request message 43 to server 18 and receive a DHCPv6 reply message 43 from server 18 to complete the message exchange operation. In the example of stateless DHCPv6 (e.g., the given DHCP instance 46 being based on stateless DHCPv6), device 10 (e.g., the given DHCP instance 46) may not need to further transmit DHCPv6 messages 43 to or receive DHCPv6 messages 43 from server 18 at least because the DHCPv6 reply message 44 may already provide device 10 (e.g., the given DHCP instance 46) with the desired device configuration information.

Configured in this manner, DHCP instances 46 may be executed in parallel and multiple device configuration request messages may be pending at the same time (e.g., DHCP instances 46 may all be awaiting their respective device configuration response messages). This helps reduce the amount of time that device 10 needs to obtain the desired device configuration information 40 when operating in an unknown networking environment (e.g., unsure of the network address assignment protocol, device identifier, and/or other parameters being used in the networking environment).

While different DHCP instances 46 are described in connection with FIGS. 3-5 to perform respective parts of the device network address assignment operations, this is merely illustrative. Processing circuitry 28 may be organized in any suitable manner (e.g., DHCP instances 46 may be executed as part of the execution of device provisioning agent 36 and/or as part of a combined application) to perform the device network address assignment operations described in connection with FIGS. 3-5. Accordingly, processing circuitry 28 may sometimes be described herein to perform the device network address assignment operations instead of specifically referring to the one or more agents, processes, kernel, and/or DHCP instances executed by processing circuitry 28.

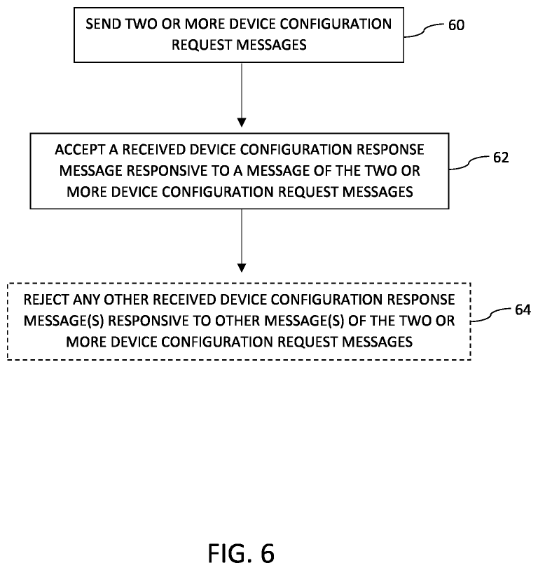

FIG. 6 is a flowchart of illustrative operations for handling multiple device configuration request messages. These operations may be performed at one or more processors of processing circuitry 28 in device 10. The illustrative operations described in connection with FIG. 6 may generally be performed by processing circuitry 28 in device 10 by executing software instructions stored on memory circuitry 30. If desired, one or more operations described in connection with FIG. 6 may be performed by other dedicated hardware components in device 10. In an illustrative configuration described herein as an example, the operations described in connection with FIG. 6 may be performed by DHCP instances 46 or generally by processing circuitry 28 on which they are implemented.

At block 60, device 10 (e.g., DHCP instances 46 executing on processing circuitry 28) may transmit (e.g., send) two or more device configuration request messages (e.g., messages 42 in FIGS. 3 and 5) destined for one or more network address assignment servers. These two or more device configuration request messages may be pending in parallel. In other words, DHCP instances 46 may await responses to these two or more device configuration request messages in parallel. Each device configuration request message may be allocated a corresponding time period for receiving a response, and in configurations described herein as an illustrative example, the allocated time periods for receiving responses may at least partially overlap each other when the two or more device configuration request messages are pending in parallel. In other words, responses to these two or more device configuration request messages are expected within an overlapping time period within and overlapping each of the allocated time periods (e.g., the allocated time periods may have respective portions that temporally overlap each other, the overlapping portions spanning at least a portion of the entire time period allocated for receiving responses to the two or more device configuration request messages).

At block 62, device 10 (e.g., a given DHCP instance 46 executing on processing circuitry 28) may receive and subsequently accept a device configuration response message (e.g., message 44 in FIGS. 3 and 5) that is responsive to one of the two or more device configuration request messages sent at block 60. In some illustrative configurations, device 10 may accept the device configuration response message by in turn completing a message exchange operation (with server 18) using the given DHCP instance 46 based on which the device configuration response message has been received. In particular, the given DHCP instance 46 may use a particular protocol and a particular set of parameters (e.g., a particular device identifier of device 10) and completing the message exchange operation may entail using the particular protocol and the set of parameters (e.g., the particular device identifier of device 10). By completing the message exchange operation, device 10 may obtain the desired device configuration information (e.g., information 40 in FIG. 3)

In some scenarios, device 10 may receive multiple device configuration response messages 44. Device 10 may accept a given one of the multiple received device configuration response messages 44 as described in connection with block 62. If desired, the accepted device configuration response message may be a first-received device configuration response message 44, may be a device configuration response message 44 using a preferred protocol (e.g., DHCPv6 preferred over DHCPv4), or may be a device configuration response message 44 selected based on any other suitable criteria.

Additionally, device 10 (e.g., other DHCP instance(s) 46 executing on processing circuitry 28) may reject any other remaining received device configuration response message(s) responsive to the other request message(s) of the two or more device configuration request messages sent at block 60. In some illustrative configurations, device 10 may reject any device configuration response message(s) by terminating the DHCP instance(s) based on which these other device configuration response messages have been received.

The example of FIG. 6 illustrates how a set of device configuration request messages pending in parallel may be handled. If desired, in some illustrative arrangements, multiple sets of parallelly-pending device configuration request messages may be used to perform device network address assignment operations to obtain device configuration information.

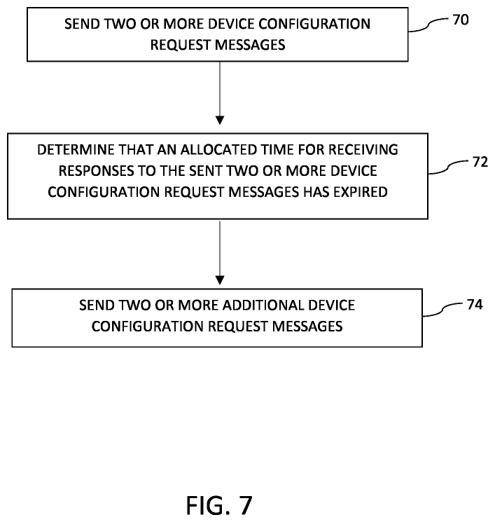

FIG. 7 is a flowchart of illustrative operations for sequentially sending two sets of device configuration request messages. These operations may be performed at one or more processors of processing circuitry 28 in device 10. The illustrative operations described in connection with FIG. 7 may generally be performed by processing circuitry 28 in device 10 by executing software instructions stored on memory circuitry 30. If desired, one or more operations described in connection with FIG. 7 may be performed by other dedicated hardware components in device 10. In an illustrative configuration described herein as an example, the operations described in connection with FIG. 7 may be performed by DHCP instances 46 or generally by processing circuitry 28 on which they are implemented.

At block 70, device 10 (e.g., DHCP instances 46 executing on processing circuitry 28) may transmit (e.g., send) two or more device configuration request messages (e.g., messages 42 in FIGS. 3 and 5) destined for one or more network address assignment servers. These two or more device configuration request messages may be pending in parallel. In other words, DHCP instances 46 may await responses to these two or more device configuration request messages in parallel. Each device configuration request message may be allocated a corresponding time period for receiving a response, and in configurations described herein as an illustrative example, the allocated time periods for receiving responses may at least partially overlap each other when the two or more device configuration request messages are pending in parallel. In other words, responses to these two or more device configuration request messages are expected within an overlapping time period within and overlapping each of the allocated time periods (e.g., the allocated time periods may have respective portions that temporally overlap each other, the overlapping portions spanning at least a portion of the entire time period allocated for receiving responses to the two or more device configuration request messages).

At block 72, device 10 (e.g., DHCP instances 46 executing on processing circuitry 28) may determine that an allocated time for receiving responses to the two or more device configuration request messages has expired (e.g., the overlapping time period has passed). In other words, DHCP instances 46 may each determine that its individual allocated time (period) for receiving a response to its device configuration request messages sent at block 70 has expired or passed and no response to any of the device configuration request messages sent at block 60 has been received by device 10. This may be indicative of the two or more device configuration request messages failing to obtain the desired device configuration information (e.g. information 40 in FIG. 3).

Based on determining that the allocated time for receiving the responses has expired (as determined at block 72), device 10 may terminate the initial set of DHCP instances 46 which have failed to obtain the desired device configuration information. At block 74, device 10 (e.g., additional DHCP instances 46 executing on processing circuitry) may transmit (e.g., send) two or more additional device configuration request messages (e.g., messages 42 in FIGS. 3 and 5). These two or more additional device configuration request messages may also be pending in parallel. In other words, additional DHCP instances 46 may await responses to these two or more additional device configuration request messages in parallel. Each additional device configuration request message may be allocated a corresponding time period for receiving a response, and in configurations described herein as an illustrative example, the allocated time periods for receiving responses may at least partially overlap each other when the two or more additional device configuration request messages are pending in parallel. In other words, responses to these two or more additional device configuration request messages are expected within an overlapping time period within and overlapping each of the allocated time periods (e.g., the allocated time periods may have respective portions that temporally overlap each other, the overlapping portions spanning at least a portion of the entire time period allocated for receiving responses to the two or more device configuration request messages).

Response(s) to the two or more device configuration request messages sent at block 70 (if any is received) may be handled based on the operations described in connection with blocks 62 and/or 64 in FIG. 6. Similarly, response(s) to the two or more additional device configuration request messages sent at block 74 (if any is received) may be handled based on the operations described in connection with blocks 62 and/or 64 in FIG. 6.

Configuration in which the two or more device configuration request messages sent at block 70 are preferred types of device configuration request messages associated with primary (preferred) protocols (or generally having preferred characteristics) and the two or more additional device configuration request messages sent at block 74 are backup types of device configuration request messages associated with secondary (backup) protocols are sometimes described herein as an illustrative example. If desired, any suitable types of different device configuration request messages may be sent at blocks 70 and 74.

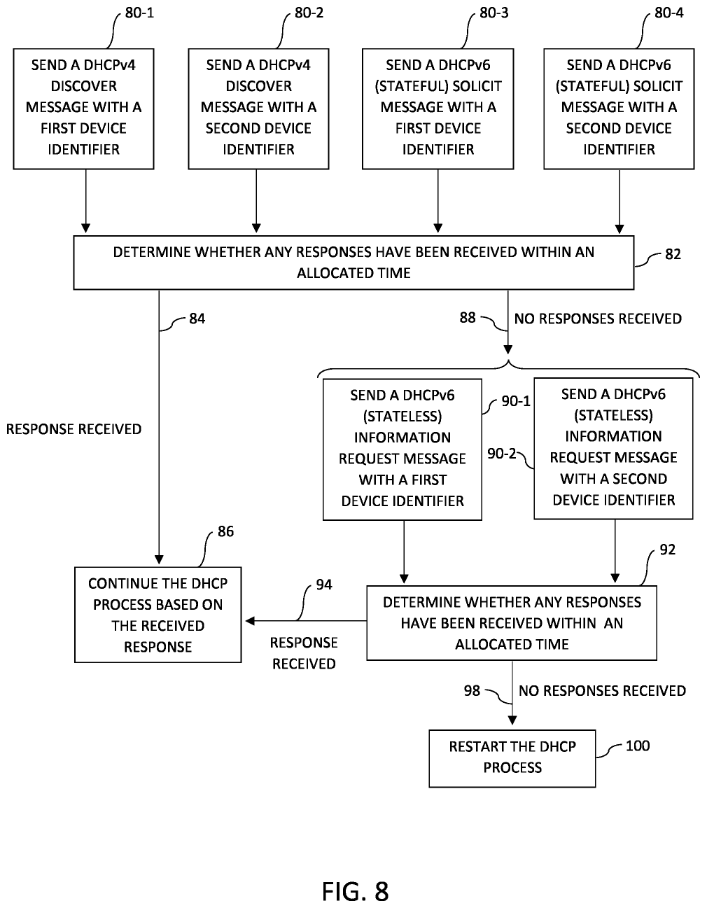

An illustrative example in which the initially sent (primary) types of device configuration request messages are messages associated with one or more stateful protocols (e.g., DHCPv4 and stateful DHCPv6) and the subsequently sent (secondary) types of device configuration request message are messages associated with one or more stateless protocols (e.g., stateless DHCPv6) is described in connection with FIG. 8.

FIG. 8 is a flowchart of illustrative operations for obtaining device configuration information with parallelization using stateful and stateless protocols. These operations may be performed at one or more processors of processing circuitry 28 in device 10. The illustrative operations described in connection with FIG. 8 may generally be performed by processing circuitry 28 in device 10 by executing software instructions stored on memory circuitry 30. If desired, one or more operations described in connection with FIG. 8 may be performed by other dedicated hardware components in device 10. In an illustrative configuration described herein as an example, the operations described in connection with FIG. 8 may be performed by DHCP instances 46 or generally by processing circuitry 28 on which they are implemented.

In particular, processing circuitry 28 on device 10 may execute (generate) and maintain multiple DHCP instances 46 in parallel to obtain device configuration information (e.g., information 40 in FIG. 3) in an efficient manner, particularly when device 10 is operating in an unknown networking environment. At block 80-1, a first DHCPv4 instance on processing circuitry 28 may transmit (e.g., send) a first DHCPv4 discover message with a first device identifier of device 10. At block 80-2, a second DHCPv4 instance on processing circuitry 28 may transmit (e.g., send) a second DHCPv4 discover message with a second device identifier of device 10. At block 80-3, a first DHCPv6 instance on processing circuitry 28 may transmit (e.g., send) a first DHCPv6 solicit message with the first device identifier of device 10. At block 80-4, a second DHCPv6 instance on processing circuitry 28 may transmit (e.g., send) a second DHCPv6 solicit message with the second device identifier of device 10.

At block 82, processing circuitry 28 may determine (e.g., each of the DHCP instances 46 may individually determine) whether any responses have been received within an allocated time. In particular, each DHCP instance 46 executing on processing circuitry 28 may maintain an allocated time within which it is expecting a response to the message sent in the corresponding block 80 (e.g., a corresponding one of blocks 80-1, 80-2, 80-3, or 80-4). When one of the DHCP instances receives a corresponding response (e.g., a device configuration response message 44), processing may proceed via path 84 to block 86, and if desired, processing circuitry 28 may terminate the other DHCP instances.

At block 86, the remaining active DHCP instance by which the response message (e.g., response message 44) has been received may continue with its DHCP process based on the received response message. As an example, if the first DHCPv4 instance that sent the message at block 80-1 receives a DHCPv4 offer message (e.g., a response message 44) from server 18, the first DHCPv4 instance continuing the DHCP process may entail transmitting a DHCPv4 request message containing the first device identifier of device 10 to server 18 and subsequently receiving a DHCPv4 acknowledge message from server 18. This may serve to complete the message exchange operation for the DHCP process. As another example, if the second DHCPv6 instance that sent the message at block 80-4 receives a DHCPv6 advertise message (e.g., a response message 44) from server 18, the second DHCPv6 instance continuing the DHCP process may entail transmitting a DHCPv6 request message containing the second device identifier of device 10 to server 18 and subsequently receiving a DHCPv6 reply message from server 18. This may serve to complete the message exchange operation for the DHCP process.

In some scenarios, none of the DHCP instances based on which messages are sent at blocks 80-1, 80-2, 80-3, and 80-4 may receive a response to the sent messages within an allocated time (e.g., within each of their corresponding allocated time periods). In other words, in response to determining that the allocated times for receiving responses for all of the DHCP instances have expired without any responses being received, processing may proceed via path 88 to blocks 90-1 and 90-2, and if desired, processing circuitry 28 may terminate the four DHCP instances that have failed to obtain the desired device configuration information.

After failing to complete the message exchange operation for any of the stateful protocol instances, device 10 (e.g., device provisioning agent 36 on processing circuitry 28) may attempt stateless device address assignment operations. In particular, as described in connection with FIGS. 3 and 4, device 10 may internally generate its network address (e.g., an IPV6 address) based at least in part on information obtained from router 12 (e.g., in a router advertisement message from router 12). While device 10 may generate its own network address in this manner (e.g., using SLAAC), device 10 may need to complete its configuration using stateless protocol instances. In particular, processing circuitry 28 on device 10 may execute (generate) and maintain multiple additional (stateless) DHCP instances 46 in parallel to obtain device configuration information (e.g., information 40 in FIG. 3) in an efficient manner, particularly when device 10 is operating in an unknown networking environment.

Accordingly, at block 90-1, a first stateless DHCPv6 instance on processing circuitry 28 may transmit (e.g., send) a first DHCPv6 information request message with a first device identifier of device 10. At block 90-2, a second stateless DHCPv6 instance on processing circuitry 28 may transmit (e.g., send) a second DHCPv6 information request message with a second device identifier of device 10. While not explicitly shown in the example of FIG. 8, if desired, additional operations may occur prior to the operations at blocks 90-1 and 90-2 (e.g., exchange of router solicitation and router advertisement message with router 12, exchange of solicit and advertise messages with server 18 for the stateless DHCPv6 protocol, etc.).

At block 92, processing circuitry 28 may determine (e.g., each of the stateless DHCPv6 instances may individually determine) whether any responses have been received within an allocated time. In particular, each of the two stateless DHCPv6 instances 46 executing on processing circuitry 28 may maintain an allocated time within which it is expecting a response to the message sent in the corresponding block 90 (e.g., a corresponding one of blocks 90-1 or 90-2). When one of the two stateless DHCPv6 instances receives a corresponding response (e.g., a device configuration response message 44), processing may proceed via path 94 to block 86, and if desired, processing circuitry 28 may terminate the other stateless DHCPv6 instance.

As similarly described above in connection with block 86 (when proceeding via path 84), the remaining (active) stateless DHCP instance by which the response message (e.g., response message 44) has been received may continue with its DHCP process based on the received response message. As an example, if the first stateless DHCPv6 instance that sent the message at block 90-1 receives a DHCPv6 reply message from server 18, the first stateless DHCPv6 instance may continue the DHCP process by verifying that the information in the DHCPv6 reply message contains the device configuration information requested in the sent DHCPv6 information request message. This may serve to complete the message exchange operation for the stateless DHCP process.

In some scenarios, neither of the two stateless DHCP instances based on which messages are sent at blocks 90-1 and 90-2 may receive a response to the sent messages within an allocated time (e.g., within each of their corresponding allocated time periods). In other words, in response to determining that the allocated times for receiving responses for all of the stateless DHCP instances have expired without any responses being received, processing may proceed via path 98 to block 100, and if desired, processing circuitry 28 may terminate the two stateless DHCP instances that have failed to obtain the desired device configuration information.

After failing to complete the message exchange operation for any of the stateless (and the prior stateful) protocol instances, device 10 (e.g., device provisioning agent 36 on processing circuitry 28) may restart the entire DHCP process, if desired (at block 100). In some illustrative configurations described herein as an illustrative example, restarting the DHCP process may entail restarting operation at blocks 80-1, 80-2, 80-3, and 80-4. If desired, restarting DHCP process at block 100 may entail performing other operations not explicitly shown in FIG. 8 (e.g., using other protocols to send device configuration request messages, transmitting device configuration request messages using another (third) device identifier, storing information indicating failure of the DHCP process, and/or reporting the failure of the DHCP process to a management device or system for output to a network administrator).

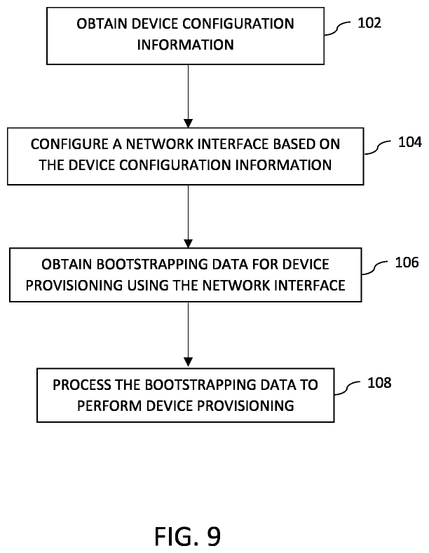

FIG. 9 is a flowchart of illustrative operations for performing device provisioning using the obtained device configuration information (e.g., information 40 in FIG. 3). These operations may be performed at one or more processors of processing circuitry 28 in device 10. The illustrative operations described in connection with FIG. 9 may generally be performed by processing circuitry 28 in device 10 by executing software instructions stored on memory circuitry 30. If desired, one or more operations described in connection with FIG. 9 may be performed by other dedicated hardware components in device 10. In an illustrative configuration described herein as an example, the operations described in connection with FIG. 6 may be performed by device provisioning agent 36, kernel 38, and DHCP instances 46, or generally by processing circuitry 28 on which they are implemented.

At block 102, processing circuitry 28 (e.g., device provisioning agent 36 and one or more DHCP instances 46) may obtain device configuration information (e.g., a network address of device 10 and/or other device configuration information as described in connection with information 40 of FIG. 3). As examples, processing circuitry 28 may execute one or more DHCP instances (e.g., based on instructions from device provisioning agent 36) in the manner described in connection with the operations in any of FIGS. 6-8 to obtain the device configuration information. If desired, processing circuitry 28 may generally perform one or more of the operations described herein with respect to the parallelization of the device configuration request messages (e.g., as described in connection with FIGS. 3-8) to obtain the desired device configuration information.

At block 104, processing circuitry 28 (e.g., kernel 38) may configure one or more network interfaces (e.g., IPv4 and/or IPv6 network layer interfaces) based on the obtained device configuration information. The device configuration information based on which processing circuitry 28 (e.g., kernel 38) configures the network interface(s) may include a device network address (e.g., address 41 in FIG. 3), subnet mask information, one or more available router (sometimes referred to as default gateway) IP addresses, one or more domain name system (DNS) server addresses, domain name information, and a device network address lease time, as just a few examples.

At block 106, processing circuitry 28 (e.g., device provisioning agent 36) may obtain bootstrapping data for device (self-) provisioning using the configured network interface(s). The bootstrapping data may be obtained by communicating with (e.g., sending packets via the network interface(s) to and receiving packets via the network interface(s) from) any suitable source of bootstrapping data such as bootstrapping server 20 (FIG. 1). As examples, the bootstrapping data may include executable files such as compiled binary executable files and/or script-based executable files, files for storage (e.g., networking data such as forwarding decision data, routing decision data, network policy information, etc.), and/or any other suitable types of data.

At block 108, processing circuitry 28 (e.g., device provisioning agent 36) may process the bootstrapping data to perform device (self-) provisioning. As examples, as part of processing the bootstrapping data, processing circuitry 28 may execute any suitable executable files, store any files intended for storage (e.g., at memory circuitry 30 and/or memory circuitry associated with packet processor(s) 32), and/or may generally perform suitable action(s) for corresponding types of data in the bootstrapping data.

The operations described in connection with each of FIGS. 6-9 are merely illustrative. If desired, one or more these operations within any of FIGS. 6-9 may be omitted and/or changed. If desired, one or more additional operations may be performed in addition to the operations described in connection with any of FIGS. 6-9. If desired, the order of the operations described in connection with any of FIGS. 6-9 may be changed. If desired, some operations described in connection with each of FIGS. 6-9 may be performed in parallel with each other (e.g., across multiple components such as across multiple processors of device 10) and/or some operations described in connection with each of FIGS. 6-9 may be performed sequentially (e.g., at only a single component such as at a processor of network device 10).

The methods and operations described above in connection with FIGS. 1-9 may be performed by the components of one or more network devices and/or server or other host equipment using software, firmware, and/or hardware (e.g., dedicated circuitry or hardware). Software code for performing these operations may be stored on one or more non-transitory computer-readable storage media (e.g., tangible computer readable storage media) on one or more of the components of the network device(s) and/or server or other host equipment. The software code may sometimes be referred to as software, data, instructions, program instructions, or code. The non-transitory computer-readable storage media may include drives, non-volatile memory such as non-volatile random-access memory (NVRAM), removable flash drives or other removable media, other types of random-access memory, etc. Software stored on the non-transitory computer readable storage media may be executed by processing circuitry on one or more of the components of the network device(s) and/or server or other host equipment (e.g., processing circuitry 28 in network device 10).

The foregoing is merely illustrative and various modifications can be made to the described embodiments. The foregoing embodiments may be implemented individually or in any combination.

What is claimed is:

1. A method of obtaining device configuration information, the method comprising:
transmitting, by a network device, a first device configuration request message for reception at a network address assignment server;
transmitting, by the network device and prior to receiving a response to the first device configuration request message, a second device configuration request message for reception at the network address assignment server;
receiving, by the network device, a device configuration response message from the network address assignment server in response to the first device configuration request message or the second device configuration request message; and
configuring, by the network device, a network interface based on information in the device configuration response message.

2. The method defined in claim 1, wherein the first device configuration request message comprises a first Dynamic Host Configuration Protocol (DHCP) message containing a first device identifier of the network device and wherein the second device configuration request message comprises a second DHCP message containing a second device identifier of the network device.

3. The method defined in claim 2, wherein the first and second device identifiers comprise two device identifiers selected from the group consisting of: a device serial number, a device hardware address, a domain name system (DNS) name, a link-layer address with time information, a link-layer address, an enterprise number with additional enterprise-specific information, and a universally unique identifier.

4. The method defined in claim 2, wherein the first DHCP message is a first Dynamic Host Configuration Protocol version 4 (DHCPv4) discover message containing the first device identifier, wherein the second DHCP message is a second DHCPv4 discover message containing the second device identifier, and wherein the device configuration response message is a DHCPv4 offer message.

5. The method defined in claim 2, wherein the first DHCP message is a first Dynamic Host Configuration Protocol version 6 (DHCPv6) solicit message containing the first device identifier, wherein the second DHCP message is a second DHCPv6 solicit message containing the second device identifier, and wherein the device configuration response message is a DHCPv6 advertise message.

6. The method defined in claim 2, wherein the first DHCP message is a first Dynamic Host Configuration Protocol version 6 (DHCPv6) information request message containing the first device identifier, wherein the second DHCP message is a second DHCPv6 information request message containing the second device identifier, and wherein the device configuration response message is a DHCPv6 reply message.

7. The method defined in claim 1, wherein the first device configuration request message comprises a first message associated with a first protocol and wherein the second device configuration request message comprises a second message associated with a second protocol.

8. The method defined in claim 1, wherein the network device is awaiting, during at least partially overlapping periods of time, responses to the first and second device configuration request messages.

9. The method defined in claim 1 further comprising:
transmitting, by the network device and prior to receiving responses to the first and second device configuration request messages, a third device configuration request message; and
transmitting, by the network device and prior to receiving responses to the first, second, and third device configuration request messages, a fourth device configuration request message.

10. The method defined in claim 9, wherein the network device is awaiting, during at least partially overlapping periods of time, responses to the first, second, third, and fourth device configuration request messages.

11. The method defined in claim 1 further comprising:
obtaining, by the network device, bootstrapping data for device provisioning using the configured network interface.

12. The method defined in claim 1, wherein the information in the device configuration response message comprises at least one of an assigned network address of the network device, subnet mask information, default gateway information, domain name system (DNS) server information, or domain name information.

13. One or more non-transitory computer-readable storage media comprising computer-executable instructions that, when executed by one or more processors in a network device, cause the one or more processors to:
send first and second device configuration request messages containing different information, wherein the one or more processors are awaiting, during at least a portion of a period of time, responses to the first and second device configuration request messages;
receive a device configuration response message from a network address assignment server that is responsive to the first device configuration request message or the second device configuration request message within the time period; and
complete a message exchange operation based on the device configuration response message to obtain a network address for the network device.

14. The one or more non-transitory computer-readable storage media defined in claim 13, wherein the first device configuration request messages is sent based on a first protocol and the second device configuration request message is sent based on a second protocol, wherein the received device configuration response message is responsive to the second device configuration request message, and wherein the message exchange operation is completed based on the second protocol.

15. The one or more non-transitory computer-readable storage media defined in claim 13, wherein the first device configuration request messages contains a first device identifier for the network device and the second device configuration request message contains a second device identifier for the network device, wherein the received device configuration response message is responsive to the first device configuration request message and based on the first device identifier, and wherein the message exchange operation is completed based on the first device identifier.

16. An un-provisioned network device configured to perform device self-provisioning, the un-provisioned network device comprising:
a packet processor;
memory circuitry; and
processing circuitry coupled to the memory circuitry and the packet processor and configured to perform device self-provisioning by:
sending two or more device configuration request messages that are pending in parallel for at least a portion of a time period;
in response to not receiving responses to the two or more device configuration request messages within the time period, sending two or more additional device configuration request messages that are pending in parallel for at least a portion of an additional time period;
configuring a network interface using device configuration information based on a response to one of the two or more device configuration request messages and the two or more additional device configuration request messages;
obtaining bootstrapping data using the configured network interface; and
processing the bootstrapping data to provision the un-provisioned network device.

17. The un-provisioned network device defined in claim 16, wherein the network interface is configured using a network address assigned to the un-provisioned network device by a network address assignment server.

18. The un-provisioned network device defined in claim 17, wherein the response is responsive to one of the two or more device configuration request messages and wherein the response includes the assigned network address and additional device configuration information.

19. The un-provisioned network device defined in claim 16, wherein the network interface is configured using a network address of the un-provisioned network device generated internally by the un-provisioned network device.

20. The un-provisioned network device defined in claim 19, wherein the response is responsive to one of the two or more additional device configuration request messages and wherein the response includes additional device configuration information and excludes the internally generated network address.
